(19) United States
(12) Patent Application Publication
(10) Pub. No.: US 2014/0278741 A1
(43) Pub. Date: Sep. 18, 2014

(54) CUSTOMER COMMUNITY ANALYTICS

(71) Applicant: INTERNATIONAL BUSINESS MACHINES CORPORATION, Armonk, NY (US)

(72) Inventors: Vishal S. Batra, Noida (IN); Raghuram Krishnapuram, Bangalore (IN); Mukesh K. Mohania, New Delhi (IN)

(73) Assignee: INTERNATIONAL BUSINESS MACHINES CORPORATION, Armonk, NY (US)

(21) Appl. No.: 13/832,346

(22) Filed: Mar. 15, 2013

(51) Int. Cl. G06Q 30/02

(52) U.S. Cl. CPC G06Q 30/0201
USPC 705/7.29

(57) ABSTRACT

A method, system and software for using customer community analytics for: (i) discovering relationships (for example, financial transactional relationships) between customers and other entities (such as companies); (ii) representing the customers, other entities and their relationships in the form of a machine readable graph; and (iii) using the graph to perform graph-based functions. These functions may include: up-selling, cross-selling, making personalized recommendations, discovering a financial products supply chain and/or facilitating social interactions between and among customers and other entities.

### FIELD OF THE INVENTION

The present invention relates generally to the field of community analytics, and more particularly to customer community analytics for use by an enterprise.

### BACKGROUND OF THE INVENTION

Analytics is the process of discovery of meaningful insights from data. Analytics is typically used in areas rich with recorded information. To quantify performance, analytics relies on: (i) statistics; (ii) computer programming; and (iii) operations research. Analytics typically uses data visualization to communicate insight. Enterprises commonly apply analytics to business data, to describe, predict, and improve business performance. Some representative known applications of analytics include: (i) enterprise decision management; (ii) retail analytics; (iii) store assortment; (iv) SKU (stock-keeping unit) optimization; (v) marketing optimization; (vi) marketing mix analytics; (vii) web analytics; (viii) sales force sizing and optimization; (ix) price and promotion modeling; (x) predictive science; (xi) credit risk analysis; and (xii) fraud analytics.

### SUMMARY

According to an aspect of the present invention, there is a method for gathering information about customers of an enterprise. The method includes the following steps (not necessarily in the following order): (i) receiving information about the customers from the enterprise; (ii) performing customer community analytics on the received information; and (iii) generating a machine readable customer community analytics graph based, at least in part, upon the customer community analytics performed at the performing step. At least the performing step and the generating step are performed by computer software running on computer hardware.

### BRIEF DESCRIPTION OF THE SEVERAL VIEWS OF THE DRAWINGS

FIG. 1 is a schematic view of a first embodiment of a computer system (that is, a system including multiple sub-systems which respectively include data processing devices) according to the present invention;

FIG. 2 is a schematic view of a portion of the first embodiment computer system;

FIG. 3 is a flowchart showing a process according to an embodiment of the present invention;

FIG. 4 is a schematic view of a portion of the first embodiment computer system;

FIG. 5 is a first screenshot generated by the first embodiment computer system;

FIG. 6 is a first graph of a customer community generated by an embodiment of the present invention;

FIG. 7 is an orthographic top view of a check according to an embodiment of the present invention; and

FIG. 8 is a second graph of a customer community generated by an embodiment of the present invention.

### DETAILED DESCRIPTION

The DETAILED DESCRIPTION section will be divided into the following sub-sections: (i) The Hardware and Software Environment; (ii) Operation of Embodiment(s) of the Present Invention; (iii) Further Comments And/Or Embodiment(s); and (iv) Definitions.

### I. The Hardware and Software Environment

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java (note: the term(s) “Java” may be subject to trademark rights in various jurisdictions throughout the world and are used here only in reference to the products or services properly denominated by the marks to the extent that such trademark rights may exist), Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

The present invention will now be described in detail with reference to the Figures. FIGS. 1 and 2, collectively, make up a functional block diagram illustrating various portions of computer system (also called distributed data processing system) 100, including: enterprise server computer sub-system 102; client computer sub-systems 104, 106, 108, 110, 112; communication network 114; enterprise server computer 200; communication unit 202; processor set 204; input/output (i/o) interface(s) 206; memory device 208; persistent storage device 210; display device 212; external device set 214; random access memory (RAM) device 230; cache memory device 232; enterprise software 240; and customer community analytics program 244. The operation of customer community analytics program 244 will be discussed in detail, below, in the following sub-section of this DETAILED DESCRIPTION section.

As shown in FIG. 2, computer sub-system 102 is, in many respects, representative of the various computer sub-system(s) in the present invention. Accordingly, several portions of computer sub-system 102 will now be discussed in the following paragraphs.

Server computer sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. Software 240 is a representative set of program(s) in the form of a collection of machine readable instructions and data that is used to create, manage and control certain software functions that will be discussed in detail below.

Computer sub-system 102 is capable of communicating with other computer sub-systems via network 114 (see FIG. 1). Network 114 can be, for example, a local area network (LAN), a wide area network (WAN) such as the internet, or a combination of the two, and can include wired, wireless, or fiber optic connections. In general, network 114 can be any combination of connections and protocols that will support communications between server and client sub-systems.

It should be appreciated that FIGS. 1 and 2, taken together, provide only an illustration of one implementation (that is, system 100) and do not imply any limitations with regard to the environments in which different embodiments may be implemented. Many modifications to the depicted environment may be made, especially with respect to current and anticipated future advances in cloud computing, distributed computing, smaller computing devices, network communications and the like.

As shown in FIG. 2, computer sub-system 102 is shown as a block diagram with many double arrows. These double arrows (no separate reference numerals) represent a communications fabric, which provides communications between various components of computer sub-system 102. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for computer sub-system 102; and/or (ii) devices external to computer sub-system 102 may be able to provide memory for use by computer sub-system 102.

Software 240 is in many respects representative of the various software of the present invention and is stored in persistent storage 210 for access and/or execution by one or more of the respective computer processor(s) 204, usually through one or more memories of memory 208. Persistent storage 210 is at least more persistent than a signal in transit is, but the persistent storage may, of course, be substantially less persistent than permanent storage. Software 240 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communication unit 202, in these examples, provides for communications with other data processing systems or devices external to sub-system 102, such as client computer sub-systems 104, 106, 108, 110, 112. In these examples, communication unit 202 includes one or more network interface cards. Communication unit 202 may provide communications through the use of either or both physical and wireless communications links. Any software modules discussed herein may be downloaded to a persistent storage device (such as persistent storage device 210) through a communications unit (such as communications unit 202).

I/O interface(s) 206 allows for input and output of data with other devices that may be connected locally in data communication with server computer 200. For example, I/O interface(s) 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, mod 240, can be stored on such portable computer-readable storage media. In these embodiments the relevant software may (or may not) be loaded, in whole or in part, onto persistent storage device 210 via I/O interface(s) 206. I/O interface(s) 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

### II. Operation of Embodiment(s) of the Present Invention

“Customer community analytics,” is a term used herein to describe methods and/or associated machine logic that discovers how customers are connected with other customers of an enterprise and/or with third parties who may, or may not, have direct dealings with the enterprise. The exact link connecting customers with other customers varies from enterprise to enterprise and with the analytics scenario. For example, in the banking industry, one of the links connecting banking customers with each other is the payment/fund exchanged between or among them. There can be multiples of such groups or communities consisting of customers linked with each other. The link is a vector because it generally consists of several attributes such as: (i) amount of funds transferred; (ii) direction of transfer; (iii) mode of transfer (for example, electronic transfer, check, recurring transfer, etc.); and/or (iv) transfer of funds between customers belonging to different industries, geographies, etc.

The customer community also consists of other business entities such as entities offering banking support products (for example, credit cards, term deposit, insurance, etc.) to whom customers have transacted with and have made certain payment/funds transfer towards such products. For example, the quarterly payment made towards vehicle insurance establishes a link between the customer and that product, and, therefore, such products are also included in the customer communities discovered by the proposed method. The method that will now be described also discovers links between the customers of an enterprise with other customers and business entities outside the enterprise. For example in banking, if a customer having his account in Bank A purchases insurance from Insurance Company B and makes premium payments for the insurance policy from his Bank A account, then the customer community inferred in this case will also include the external products subscribed by this customer. Similarly, any payments or fund transfers made to other customers outside the bank are also inferred by the method and such entities are also included in the customer community analysis. The customers include all types of customers of an enterprise. In banking, for example, the customer set includes retail, corporate, small and medium enterprises (SME), etc.

The customer community analysis in the method to now be described assists the enterprise to infer customer communities of interest and relevant entities in each such community with any hot spot (the concept of a “hot spot” will be discussed further, below, in connection with step S336 of process 300a shown in FIG. 3). This analysis assists the enterprise to identify cross-sell and/or up-sell opportunities with existing customers, new customer leads for acquisition as well as industry specific insights such as financial supply chain among customers and products in the banking industry which can assist banks in performing financial risk analysis.

The method embodiment of the invention to be described below goes beyond customer analytics segmenting customers and inferring customer behavior. The method to be described below is relevant and applicable to industries where customers are connected and/or linked to each other. The customer community analytics of the method to be described below is founded on such links among customers and therefore goes beyond merely performing analytics on individual customer data.

As shown in FIG. 3, a flowchart depicts process 300 according to an embodiment of the present invention. The various steps of process 300 will now be discussed in turn.

Processing begins at step S301 where enterprise software 240 (see FIG. 2) controls and manages users (not shown, see Definitions sub-section, sometimes also referred to as “customers”) in performing financial transactions through client computer sub-systems 104, 106, 108, 110, 112 and communication network 114. In this example, the enterprise is a “banking domain” which offers banking services, insurance, home refinancing and the like. Financial transactions module (mod) 401 of customer community analytics program 244 (see FIG. 4) receives selected data regarding the users and their respective transaction from the larger set of enterprise software 240.

Processing proceeds to step S302 where analyze customer related data mod 402 (see FIG. 4) analyzes the customer data received at step S301. This analysis will usually involve analytics-type analysis and perhaps other types of analysis as well. The analytics and/or other analysis will be described in greater detail, below, in the next sub-section of this document. The analytics-type analysis includes customer community analytics. Customer community analytics will be described in greater detail, below, in the next sub-section of this document.

Processing proceeds to step S303 where generate graph sub-mod 403 of community graph mod 404 based on the customer community analytics of step S302. This graph (not shown in FIGS. 3 and 4) represents: (i) customers and/or other entities; and (ii) relationships (such as transactional relationships) between customers of the bank and/or other entities. A visual and/or human comprehensible version of the graph may, or may not, be made as part of the process of generating the graph. However, this graph be made to exist at least in machine readable form and format for later reference and use. An example of a graph will be discussed, below, in the next sub-section of this DETAILED DESCRIPTION section with reference to FIGS. 6 and 8.

Processing proceeds to step S310 where social interactions sub-mod 410 (see FIG. 4) takes action to facilitate a social interaction by the user based on the graph generated (or at least updated) at step S303. An example of this is shown in FIG. 5 at screenshot 500 where social interactions sub-mod 410 has caused pop-up window 502 to displayed to the user upon the user's purchase of an insurance policy. This pop-up is triggered because the purchase of the insurance policy is analyzed in step S302 and reflected in the graph at step S303. Based on the graph, social interactions sub-mod 410 determines that this successful purchase of a new insurance policy is a good opportunity for the customer to have a social interaction, telling others (anonymously) about the new purchase. As shown in FIG. 5, the customer is invited by pop-up window 502 to share the purchase in the community blog maintained by the bank (or by a third party) using a pre-configured message. It is noted that this is just one illustrative example of facilitation of a social interaction that a customer in the customer community may engage in.

Processing proceeds to step S312 where personalized recommendations, cross-sell, up-sell sub-mod 412 (see FIG. 4) uses the graph, generated at step S303, to make personalized recommendations to a bank customer who is at the bank's web site and/or engaging in financial transactions with the bank through the bank's website. The customer recommendation may be made at any specific location within the bank's website (for example, transactional part of the website, informational part of the website, social part of the website), or at any time at which the user is “in” the bank's website, but the system should preferably be designed so that the customer does not feel that the personalized recommendation is intrusive to her web experience and/or unduly distracting from her finance-related business to be conducted. Besides personalized recommendations, sub-mod 412 may also facilitate cross-selling and/or up-selling based upon the graph generated at step S303.

Processing proceeds to step S314 where customer care sub-mod 414 (see FIG. 4) uses the graph generated at step S303 to improve customer care in one or more of the various ways of improving customer care now known or to be developed in the future.

Processing proceeds to step S320 where financial supply chain pattern sub-mod 420 of financial supply chain mod 418 (see FIG. 4) uses the graph generated at step S303 to discover a financial supply chain pattern. This is one specific form of customer community analytics, although some of the focus is on financial entities. A couple of examples of financial supply chain patterns, discovered by the customer community analytics according to some embodiments of the present invention, will be identified, below, in connection with FIG. 6.

Processing proceeds to step S322 where discover financial product sub-mod 422 uses the financial supply chain pattern to discover a financial services product used by a financial services customer.

Processing proceeds to step S324 where risk analytics mod 424 (see FIG. 4) performs risk analytics. The risk analytics may be based upon the graph generated at step S303 and/or the financial supply chain pattern discovered at step S320.

Processing proceeds to step S330 where collect data sub-mod 430 of market and/or social media data mod 429 (see FIG. 4) collects market and/or social media data. The next sub-section of the DETAILED DESCRIPTION section identifies some possible sources of this social media and/or marketing data. Communication unit 202 (see FIG. 2) and/or network 114 (see FIG. 1) may be instrumental in collecting the social media and/or marketing data under control and management of collect data sub-mod 430.

Processing proceeds to step S332 where marketing plan sub-mod 432 (see FIG. 4) creates and/or prioritizes a marketing plan based, at least in part, on the data collected at step S330.

Processing proceeds to step S334 where acquire new customers sub-mod 434 acquires new SME and/or retail customers based, at least in part, upon the graph generated at step S303 and/or the market and/or social media data collected at step S330.

It is noted that each and every step of the foregoing process 300 will be performed and re-performed (not necessarily in order) as the bank enterprise does business through its website with its numerous customers. The graph generated by step S303 will tend to be expanded and enriched over time, as will the financial supply chain patterns discovered at step S320 and the market and/or social media data collected at step S330. This will generally work to the benefit of the customer in both the financial aspect and the social aspect of the customer's experience at the bank's website.

Processing proceeds to step S336 where hot spot mod 436 (see FIG. 4) detects “hot spot(s)” and responds to detected hot spot(s). The term “hot spot” is used herein to refer to a node (or set of nodes) on a customer community analytics graph that has an unexpectedly large number of other nodes connecting into it. These hot spots will often be nodes of special interest to a bank, or other enterprise performing customer community analytics according to an embodiment of the present invention. For example, if multiple customers of a bank enterprise have been issued a credit card by some third party credit card issuer then multiple nodes will show connections to the third party credit card issuer's node. In this case, the much-connected-to node will be classified as a hot spot and potentially subject to further analysis.

To continue the example of the popular third party credit card issuer, the enterprise performing customer community analytics can: (i) easily identify this “concentration point” in the customer community; and (ii) leverage this concentration information for various types of responsive actions.

An example of an action taken in response to identification of a hot spot will now be discussed. A bank enterprise uses the identification of a third party credit card issuer hot spot to determine that the third party's credit card product is popular for a given set of customers (and/or potential customers) of the bank. In response, the bank enterprise: (i) identifies the beneficial features of the third party issuer's card; (ii) designs its own credit card similar features; and (iii) targets its customers (especially customers who have the third party credit card, or who share salient characteristics with those who have the third party credit card) to obtain the bank's new credit card. This is just one example of responding to a hot spot, and it will be understood that there are a great multitude of use cases and inferences that an enterprise can draw and use from hot spot analysis of a customer community analytics graph.

As a final note on hot spots, not every node which has many nodes connected to it will necessarily be considered as a “hot spot.” For example, many, many bank customers may make payments through the bank to the same electrical utility company, especially if only one company supplies electricity in the area in which the bank's customers are located. This is why “hot spot” was defined, above, in terms of an “unexpectedly” large number of connections, rather than merely as a large number of connections.

The flowchart and block diagrams in the foregoing Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

### III. Further Comments and/or Embodiment(s)

In today's extremely competitive environment, enterprises want to understand their customer needs and behavior better for many reasons, such as: (i) to offer personalized recommendations; (ii) cross/up sell, etc.; (iii) to prevent any opportunity loss; and/or (iv) to improve customer care. Some embodiments provide customer community analytics that analyze transactions and other customer related data in the enterprise information systems to discover how and where customers are linked among each other and with other products/offerings or enterprises and the nature of this association. Some embodiments use this customer-relation (community) graph so that the enterprise can seamlessly understand potential customers and needs of existing customers to cross/up sell and also to retain customers.

As shown in FIG. 6, a process for discovering a customer community for a Bank will now be discussed with reference to graph (or diagram) 600, which includes: potential customer C node 602; potential customer D node 604; L SME node 606; customer A node 610 (bank account number 123); customer B node 612 (bank account number 800); housing finance company node 622; fixed deposit node 624; credit card company node 626; X SME node 628 (bank account number 321); Y SME node 635 (bank account number 323); Z SME node 634 (bank account number 376); J SME node 630; and K SME node 632. In graph 600: (i) potential customers C and D 602, 604 do not have accounts with the Bank; (ii) customers A and B 610, 612 are customers of the Bank; (iii) SMEs L, J and K 606, 630, 632 are not customers of the Bank; (iv) SMEs X, Y and Z 628, 635, 634 are customers of the bank; (v) housing finance company 622 is a third party (that is, not part of the enterprise) that offers a third party product; (vi) credit card company 626 is a third party that offers a third party product; and (vii) fixed deposit 624 is an existing product of the Bank enterprise.

The process for discovering the customer community represented by graph 600 is called customer community analytics and this process involves analyzing transactions and/or other data to discover customer entities and business entities which are linked among each other by transactional relationships, personal relationships, employment relationships, contractual relationships and/or other relationships. It is noted that all of the node and relationship data of graph 600 is discovered by analyzing the data owned and controlled by the Bank entity and that graph 600 does not rely on external data.

Possible entities include: (i) individual customers of an enterprise (for example, bank, retail store, etc.); and (ii) other entities, not owned by the enterprise, such as SMEs (small and medium enterprises) and third party financial institutions.

Some embodiments provide for connecting customers for a personalized experience, for purposes such as acquiring new customers, cross/up sell, etc. In some embodiments, social networking tools are employed to connect similar customers.

One example of these features will now be set forth using an example involving a banking enterprise that sells insurance policies: (i) a retail banking customer B buys an insurance policy; (ii) using business rules (for example, edge-analytics), a pre-configured message is shown to customer B on website of the retail bank with an option to “share” the policy benefits with other customers (without disclosing identity); (iii) the “shared” message appears on the web site of the retail bank for relevant customers likely to buy insurance products; and (iv) these customers can connect and blog with customer B on the community portal to engage in discussion, learn more details, benefits, process, etc. about the policy. With regard to item (iii) in the foregoing example, relevant customers are determined based on community analytics, rules, etc. With regard to item (iv) in the foregoing example, the other customers can connect and blog with customer B by simply clicking the shared message that appears to them per item (iii). The blog provides a common platform for customers to discuss issues related to purchases made through the enterprise.

Another example of these features will now be set forth using an example involving a banking enterprise that refinances housing loans: (i) retail customer A “shares” a pre-configured message about the benefits of refinancing housing loan (without disclosing her real-world identity); (ii) the shared message appears on the website of the banking enterprise to ‘relevant’ customers having existing housing loan from a third party bank (a bank other than the banking enterprise); and (iii) the customers connect and blogs with customer A on the community portal. With regard to item (iii) in the foregoing example, customers may go to the community portal: (a) to learn more about the process, new EMI (equal monthly installment), etc.; and (b) by simply clicking on the message shown them per item (ii).

Some embodiments provide for connecting customers for a personalized experience (to acquire new SME and retail customers). In these embodiments, new products and new tools establish (soft) business relationships with potential new customers. Some examples of these new tools and/or new products will be discussed in the following paragraphs.

One such new product is a new bank check printed and/or displayed with names of transacting SMEs. In current check-printing practice, only the name and account number of a bank's customer is printed on the check. For example, if a Customer C has an account with Bank A, then a check for Customer C's account will be printed with Customer C's name and account number. However, according to some embodiments of the present invention: (i) the bank can infer entities to whom a customer frequently writes checks; and (ii) using this information, the bank can also print the name of such entity on the ‘Pay To’ section of at least some of the customer's checks. For example, a bank can issue pre-printed checks with the name of a customer's apartment company where that customer makes a monthly rent payment by check. In the corporate sector, such scenarios are more prominent—especially in supply chain, retail, manufacturing, insurance etc., where the customer issues the check to the same company repeatedly a few times a month.

Another such new product is a new bank check printed and/or displayed with a link to access transaction reports online for: (i) transactions between two companies (for example, companies called X and K); and/or (ii) transactions with a single, particular company. An example of this is shown in FIG. 7 at reference number 704 of check 700. Check 700 also includes check zone 702 which pre-prints the name of the payee on the check according to insights gleaned from the customer community analytics according to an embodiment of the present invention.

One example of a new tool is a tool to manage and track purchase orders, invoices, payments, reports and BI (business intelligence).

A process for enriching customer community profiles and/or data will now be discussed with reference to FIG. 8. More specifically, the community represented by graph 600 has been updated and enriched to form a discovered community represented by graph 800.

As shown in FIG. 8, graph (or diagram) 800, includes: potential customer C node 802; potential customer D node 804; L SME node 806; customer A node 810 (bank account number 123); customer B node 812 (bank account number 800); housing finance company node 822; credit card company node 826; X SME node 828 (bank account number 321); Y SME node 835 (bank account number 323); Z SME node 834 (bank account number 376); J SME node 830; K SME node 832 fixed deposit node 850; management and employees node set 852; management and employees node set 854; and congratulatory communication node 860.

In graph 800: (i) potential customers C and D 802, 804 do not have accounts with the Bank; (ii) customers A and B 810, 812 are customers of the Bank; (iii) SMEs L, J and K 806, 830, 832 are not customers of the Bank; (iv) SMEs X, Y and Z 828, 835, 834 are customers of the bank; (v) housing finance company 822 is a third party (that is, not part of the enterprise) that offers a third party product; (vi) credit card company 826 is a third party that offers a third party product; (vii) fixed deposit 850 is an existing product of the Bank enterprise; (viii) management and employees node sets 852, 854 are management and employees of J SME and K SME, respectively, who may or may not be bank customers themselves; and (ix) congratulatory communication node 860 represents a communication made between customer A 810 and non-customer D 804 on a third party social media site.

Using the customer community information of the types shown in FIG. 8, an enterprise can derive additional insight about relevant entities from market and social media data to: (i) create and prioritize a marketing plan; and/or (ii) acquire new SME and retail customers. This market and social media data may include, for example: (i) nature and business of SME, HQ Location, identities of executive management, number of Employees in SME, sector growth prediction, etc.; (ii) relationship between entities and social media analysis between them (for example, business partner, supplier, friend, colleague, family, etc.); (iii) employees of SME (from social media sites such as Twitter, Facebook, LinkedIn, Market Data, etc. (note: the term(s) “Twitter,” “Facebook,” “LinkedIn,” and “Market Data” may be subject to trademark rights in various jurisdictions throughout the world and the term(s) are used here only in reference to the products or services properly denominated by the marks to the extent that such trademark rights may exist)).

Some specific examples of discovery of enriched customer community data in graph 800 of FIG. 8 will now be identified: (i) analysis of data from a third party social media site discovers that non-customer C (node 802) is a spouse of customer A (node 810); (ii) analysis of data from a third party social media site discovers that non-customer D (node 804) is a spouse of customer A (node 810); (iii) analysis of data from a third party social media site discovers that customer SME X (node 828) is a supplier of non-customer SME J (node 830); (iv) analysis of data from a third party social media site discovers that customer SME Y (node 835) is a supplier of non-customer SME K (node 832); (v) analysis of data from a third party social media site discovers that non-customer SME J (node 830) has a set of managers and employees (node 852); and (vi) analysis of data from a third party social media site discovers that non-customer SME K (node 832) has a set of managers and employees (node 854).

Some embodiments have one or more of the following features: (i) discovery of a customer community (of an enterprise) based on financial transactions; (ii) discovery of a financial supply chain pattern in the customer community; (iii) discovery of a third party financial product used by a financial services customer; (iv) cross-sell and/or up-sell analytics based on a customer community and/or a financial supply chain pattern; (v) risk analytics based on a customer community and/or a financial supply chain pattern; (vi) inferring customer community/links within a bank-type enterprise (herein simply referred to as a “bank”; (vii) discovery of a customer community within a bank; (viii) self-discovery of a customer community within a bank by analyzing transactions of customers; (ix) discovery of a financial supply chain pattern among the customers within the discovered community; (x) discovery of third party products/services subscribed to by community members; (xi) cross-sell and/or up-sell offers for community members; (xii) discovery of a transaction relationship among the community members; and/or (xiii) risk alerts/analytics.

It is noted that FIGS. 6 and 8 both provide a good representation of “customer community analytics” according to an embodiment of the present invention because both these figures show: (i) links between customers; (ii) links between customers and third party businesses that do business with the enterprise; (iii) links between customers and potential customers (both individuals and/or businesses, especially small businesses); (iv) link information that reflects personal relationships (for example, spouse) rather than focusing exclusively on links based on commercial transactions; and/or (v) link information gleaned from social media websites.

### IV. Definition(s)

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

And/or: non-exclusive or; for example, A and/or B means that: (i) A is true and B is false; or (ii) A is false and B is true; or (iii) A and B are both true.

User: includes, but is not necessarily limited to, the following: (i) a single individual human; (ii) an artificial intelligence entity with sufficient intelligence to act as a user; and/or (iii) a group of related users.

What is claimed is:

1. A method for gathering information about customers of an enterprise, the method comprising:
receiving information about the customers from the enterprise;
performing customer community analytics on the received information; and
generating a machine readable customer community analytics graph based, at least in part, upon the customer community analytics performed at the performing step;
wherein:
at least the performing and generating steps are performed by computer software running on computer hardware.

2. The method of claim 1 wherein the enterprise is a financial institution.

3. The method of claim 2 wherein the enterprise is a bank.

4. The method of claim 1 further comprising the steps of:
transacting financial transactions, by the enterprise, with a plurality of customers and over a communication network; and
collecting information about the customers received by the enterprise during the transacting step;
wherein:
the information collected at the collecting step is subsequently received at the receiving step.

5. The method of claim 1 further comprising the step of:
taking, based at least in part upon the customer community analytics graph, one or more of the following actions: cross-selling, up-selling, identifying a hot spot, facilitating social interaction, making personalized recommendations, improving customer care, identifying a financial supply chain pattern, performing risk analytics, and/or prioritizing a marketing plan.

6. A computer program product for gathering information about customers of an enterprise, the computer program product including software stored in a software storage device in a manner less transient than a signal in transit, the software comprising:
first program instructions programmed to receive information about the customers from the enterprise;
second program instructions programmed to perform customer community analytics on the received information; and
third program instructions programmed to generate a machine readable customer community analytics graph based, at least in part, upon the customer community analytics performed at the performing step.

7. The product of claim 6 wherein the enterprise is a financial institution.

8. The product of claim 7 wherein the enterprise is a bank.

9. The product of claim 6 wherein the software further comprises:
fourth program instructions programmed to transact financial transactions, by the enterprise, with a plurality of customers and over a communication network; and
fifth program instructions programmed to collect information about the customers received by the enterprise during the transacting step;
wherein:
the information collected by the fifth program instructions is subsequently received by the first program instructions.

10. The product of claim 6 wherein the software further comprises:
fourth program instructions programmed to take, based at least in part upon the customer community analytics graph, one or more of the following actions: cross-selling, up-selling, identifying a hot spot, facilitating social interaction, making personalized recommendations, improving customer care, identifying a financial supply chain pattern, performing risk analytics, and/or prioritizing a marketing plan.

11. A computer system for gathering information about customers of an enterprise, the system comprising:
a processor set; and
a software storage device;
wherein:
the processor set is connected and/or structured to perform machine readable instructions stored in the software storage device; and
the software storage device has stored therein software comprising:
first program instructions programmed to receive information about the customers from the enterprise,
second program instructions programmed to perform customer community analytics on the received information, and
third program instructions programmed to generate a machine readable customer community analytics graph based, at least in part, upon the customer community analytics performed at the performing step.

12. The system of claim 11 wherein the enterprise is a financial institution.

13. The system of claim 12 wherein the enterprise is a bank.

14. The system of claim 11 wherein the software further comprises:
fourth program instructions programmed to transact financial transactions, by the enterprise, with a plurality of customers and over a communication network; and
fifth program instructions programmed to collect information about the customers received by the enterprise during the transacting step;
wherein:
the information collected by the fifth program instructions is subsequently received by the first program instructions.

15. The product of claim 11 wherein the software further comprises:
fourth program instructions programmed to take, based at least in part upon the customer community analytics graph, one or more of the following actions: cross-selling, up-selling, identifying a hot spot, facilitating social interaction, making personalized recommendations, improving customer care, identifying a financial supply chain pattern, performing risk analytics, and/or prioritizing a marketing plan.
